(19) United States
(12) Patent Application Publication
(10) Pub. No.: US 2022/0188913 A1
(43) Pub. Date: Jun. 16, 2022

(54) INFORMATION PROCESSING SYSTEM AND NON-TRANSITORY COMPUTER READABLE MEDIUM

(71) Applicant: FUJIFILM BUSINESS INNOVATION CORP., Tokyo (JP)

(72) Inventors: Akihide KAWAMURA, Kanagawa (JP); Kengo TOKUCHI, Kanagawa (JP)

(73) Assignee: FUJIFILM BUSINESS INNOVATION CORP., Tokyo (JP)

(21) Appl. No.: 17/320,802

(22) Filed: May 14, 2021

(30) Foreign Application Priority Data
Dec. 10, 2020 (JP) 2020-205281

(51) Int. Cl. G06Q 30/06; G06N 7/00

(52) U.S. Cl. CPC G06Q 30/0645; G06N 7/005

(57) ABSTRACT

An information processing system that executes processing for an object reserved by a user includes a processor configured to determine possibility information about a possibility that a first user having reserved the object will actually use the object.

### CROSS-REFERENCE TO RELATED APPLICATIONS

This application is based on and claims priority under 35 USC 119 from Japanese Patent Application No. 2020-205281 filed Dec. 10, 2020.

### BACKGROUND

### (i) Technical Field

The present disclosure relates to an information processing system and a non-transitory computer readable medium.

### (ii) Related Art

Japanese Unexamined Patent Application Publication No. 2020-107135 discloses the following reservation management system. The reservation management system includes a facility-related item management device that stores facility-related items for using a facility, a storage that stores reservation information about a reservation for using a facility, a linking unit that controls the facility-related item management device based on the reservation information, and a cancellation-waiting-request receiver that receives a cancellation waiting request for a reservation.

Japanese Unexamined Patent Application Publication No. 2002-92440 discloses the following processing. A cancellation informing unit sends information that there has been a cancellation to a terminal of a user in accordance with a queue registered in a cancellation-waiting registering unit and makes a query about whether the user wishes to make a reservation.

### SUMMARY

There may be a case in which, even if a user has made a reservation for a certain object, he/she may not actually use it.

In this case, if the possibility of the object not being used is determined in advance, it may be possible to suggest that the user cancel the reservation or to let another user make a reservation for the object. This increases the utilization of the object.

Aspects of non-limiting embodiments of the present disclosure relate to an information processing system and a non-transitory computer readable medium that can enhance the utilization of an object which may be canceled after it is reserved by a user, compared with a case in which the possibility of the actual use of this object by the user is unknown.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system that executes processing for an object reserved by a user, the information processing system including a processor configured to determine possibility information about a possibility that a first user having reserved the object will actually use the object.

### BRIEF DESCRIPTION OF THE DRAWINGS

An exemplary embodiment of the present disclosure will be described in detail based on the following figures, wherein:

FIG. 1 is a schematic diagram illustrating the overall configuration of an information processing system;

FIG. 2 illustrates a booth, which is as an example of a space;

FIG. 3 illustrates the inside of a booth as viewed from above;

FIG. 4 is a block diagram illustrating an example of the hardware configuration of a space management server;

FIG. 5 is a block diagram illustrating an example of the hardware configuration of a user terminal;

FIG. 6 illustrates an example of a display screen displayed on a user terminal when a user reserves a booth;

FIG. 7 illustrates another example of a display screen displayed on the user terminal;

FIGS. 8A through 8C illustrate a procedure of processing executed by a central processing unit (CPU);

FIGS. 9A through 9C illustrate a procedure of processing executed by the CPU when a user B makes a reservation after a user A;

FIGS. 10A through 10C illustrate examples of display screens displayed on user terminals when corresponding users make a reservation for a booth;

FIGS. 11A through 11C illustrate other display examples on user terminals;

FIG. 12 illustrates another display example on a user terminal;

FIG. 13 illustrates another example of the configuration of a booth;

FIG. 14 illustrates another example of a reservation mode for a booth;

FIG. 15 illustrates another example of a display screen displayed on a user terminal; and

FIG. 16 illustrates a display screen when reservation success probability is determined by including information regarding whether a reservation is provisional.

### DETAILED DESCRIPTION

An exemplary embodiment of the disclosure will be described below with reference to the accompanying drawings.

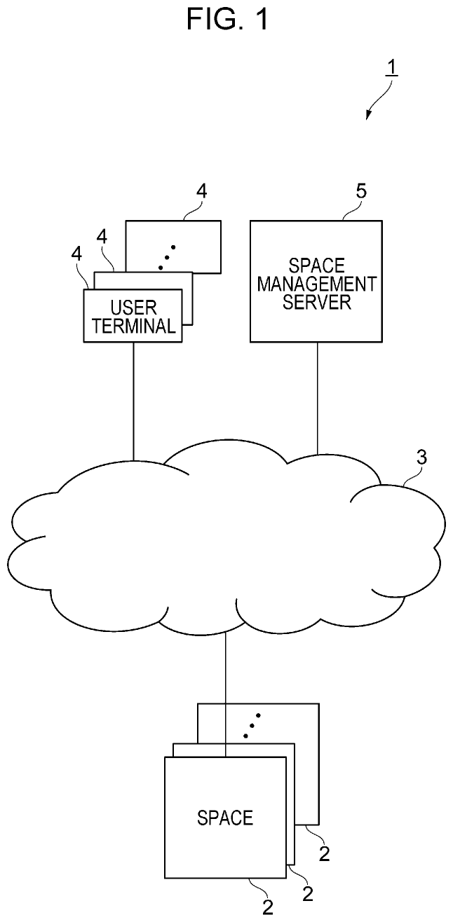

FIG. 1 is a schematic diagram illustrating the overall configuration of an information processing system 1 according to the exemplary embodiment.

In the exemplary embodiment, plural spaces 2, which are an example of a location to be reserved and used by a user, are provided. In the exemplary embodiment, a user first reserves a space 2 before the use.

One type of spaces 2 is closed spaces which are enclosed by walls or partitions. Examples of such spaces 2 are booths, rooms in accommodation facilities, and meeting rooms in companies.

Another type of spaces 2 is opened spaces. Examples of such spaces 2 are tables and seats in a restaurant and those at a barbershop at which a user receives a service.

The information processing system 1 shown in FIG. 1 includes various terminals connected to a cloud network 3.

In FIG. 1, as an example of terminals connected to the cloud network 3, user terminals 4 operated by users are shown, and as an example of an information processing apparatus that manages the spaces 2, a space management server 5 is shown. The spaces 2 are connected to the cloud network 3. More specifically, various devices are disposed in the spaces 2 and such devices are connected to the cloud network 3.

In the exemplary embodiment, an electronic lock is fixed on a door of each space 2, and each space 2 can be locked with this electronic lock. A user authorized to unlock a space 2 can use this space 2.

When unlocking a space 2, a user operates its user terminal 4 to give an instruction to unlock the space 2. This instruction is sent to the space management server 5. In response to this instruction, the space management server 5 instructs the space 2 to unlock it. This operates the electronic lock fixed on the door of the space 2 to unlock the space 2.

In the exemplary embodiment, mobile terminals such as smartphones are assumed as the user terminals 4. Alternatively, wearable terminals, laptop computers, and game machines may be used as mobile user terminals 4.

The space management server 5 manages various types of information related to the spaces 2, such as information for identifying a user, information for identifying a space 2, and a reservation start time and end time.

Information for identifying a user may be the name, gender, age, account, user ID, password, and management information for this user. Information for identifying a space 2 may be information for identifying an address or a location of the space 2 and the management name and number of the space 2.

The space management server 5 also serves as a control device to control various devices set in the spaces 2. The control device may alternatively be installed in each space 2 in association with each other. In this case, the control device disposed in each space 2 controls the various devices set in the corresponding space 2.

### (Configuration of Space 2)

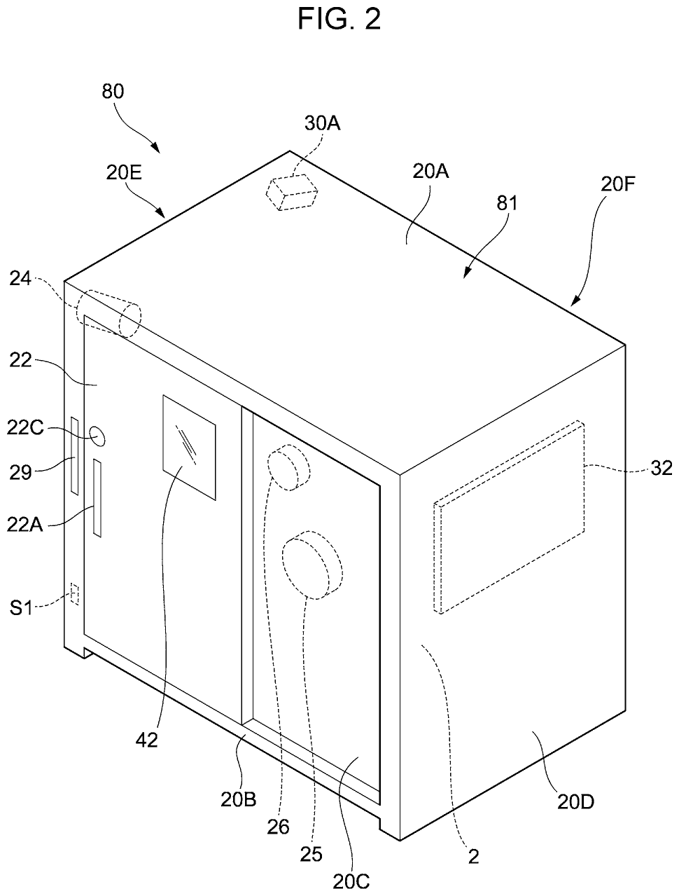

FIG. 2 illustrates a booth 80 as an example of a space 2.

In the example in FIG. 2, the inside of a booth 80 is a space 2 to be reserved. In other words, a user can reserve the inside of a booth 80 as a space 2.

Booths 80 are installed in various locations regardless of indoors and outdoors, such as in station buildings, airports, office buildings, commercial complexes (restaurants and department stores, for example), banks, libraries, art galleries, museums, public institutions, facilities, passageways, and parks.

The booth 80 shown in FIG. 2 is a closed booth 80 having a ceiling. However, “closed” does not mean “sealed”, and a closed booth may be any type of space having a practical soundproof function.

The booth 80 refers to a structure separated from an outside space with partitions. However, it is not necessary that the booth 80 be entirely surrounded by partitions. The booth 80 may be only partially provided with partitions. For example, only the left and right sides of a user inside the booth 80 may be closed with partitions. This structure is also an example of the booth 80.

The ceiling may not be necessary, and a space 2 without the ceiling is also an example of the booth 80.

In the booth 80, a housing 81, which forms the major part of the booth 80, is disposed. The housing 81 has a cuboidal shape.

The booth 80 is constituted by a ceiling 20A, a floor 20B, a wall 20C having a door 22 fixed thereto, two walls 20D and 20E at both sides of the wall 20C, and a wall 20F opposite the wall 20C.

In the exemplary embodiment, the space 2 is surrounded by the walls 20C, 20D, 20E, and 20F and the door 22 and is disposed inside of these four walls and the door 22. To put it another way, the space 2 is disposed inside the housing 81.

The door 22 can be opened and closed. In the exemplary embodiment, the door 22 is assumed to be a sliding door that can move along the wall 20C. In the example in FIG. 2, the door 22 is a single sliding door in which one door member slides. The door 22 may alternatively be a sliding door in which two or more door members slide in opposite directions on different rails or a sliding door in which one door member slides to the left and the other door member slides to the right.

A handle 22A is fixed to the door 22 for a user to hold when opening or closing the door 22. Another handle is also fixed on the door 22 inside the housing 81.

An electronic lock 22C for locking and unlocking the door 22 is fixed on the door 22. In the exemplary embodiment, a door state sensor S1 is disposed to detect the opening and closing of the door 22.

The number of users using the booth 80 is largely determined by the volume of the booth 80. In the exemplary embodiment, a private space basically for one person is assumed as the booth 80. A private space is not necessarily for only one person and may accommodate a small group of people, such as two or three people. The booth 80 may alternatively be a large booth for accommodating a large group of people.

The housing 81 of the booth 80 may be formed in any shape and structure. Facilities to be provided in the booth 80 and the capabilities of the facilities may also be selected desirably.

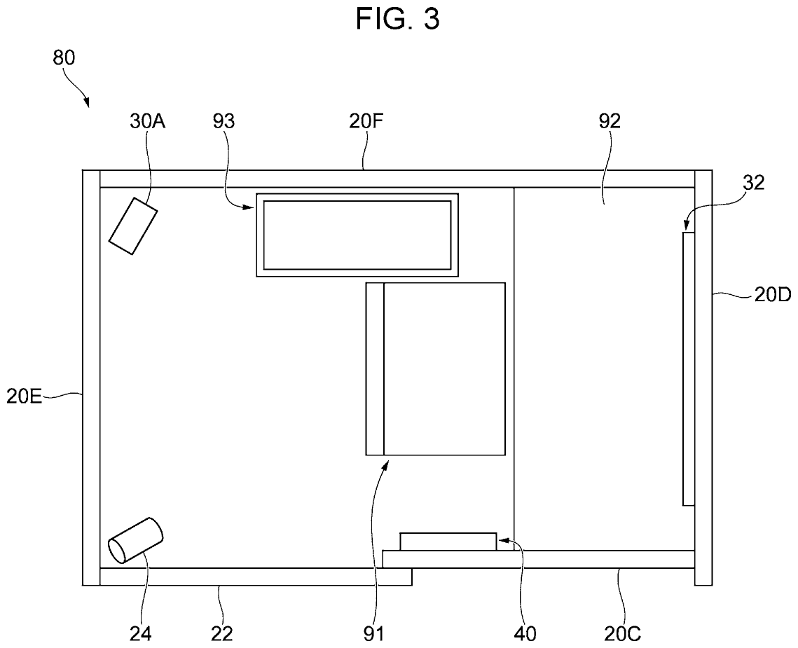

FIG. 3 illustrates the inside of the booth 80 as viewed from above.

In the example in FIG. 3, one desk 92 and one chair 91 are placed inside the booth 80.

A container 93 for a user to put his/her personal belongings is also provided inside the booth 80.

As a device installed inside the booth 80, a monitor 32, which is a display for displaying images, is disposed, as shown in FIGS. 2 and 3.

A speaker 30A, which is a sound output device that outputs sound, is also disposed, as shown in FIGS. 2 and 3. Instead of the speaker 30A, a speaker installed in the monitor 32 may be used.

An imaging device 24 that takes an image of the inside of the booth 80 is also provided, as shown in FIGS. 2 and 3. The imaging device 24 includes imaging elements, such as charge-coupled devices (CCDs) or complementary metal-oxide-semiconductors (CMOSs), and takes an image of the inside of the booth 80 by using the imaging elements.

As shown in FIG. 2, a human sensor 25 is also provided on the booth 80 to detect a user inside the booth 80, and a temperature sensor 26 is also provided to detect the temperature inside the booth 80. Lighting equipment 40 for illuminating the inside of the booth 80 is also fixed, as shown in FIG. 3.

As shown in FIG. 2, a window 42 is provided on the door 22. In the exemplary embodiment, the inside of the space 2 can be seen through the window 42 from the outside.

As shown in FIG. 2, an information obtaining device 29 for obtaining personal information about a user using the booth 80 may be disposed on the outer surface of the booth 80.

The information obtaining device 29 may be constituted by a reader for reading an identification (ID) card passing over the reader. The information obtaining device 29 may be a reader for reading biological information, such as user's fingerprints or finger vein patterns.

An air-conditioning device is also disposed in the booth 80 to adjust the temperature inside the booth 80, though it is not shown.

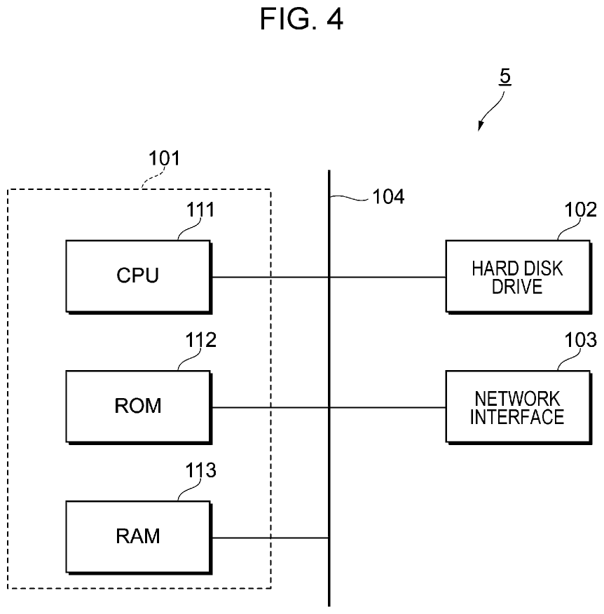

FIG. 4 is a block diagram illustrating an example of the hardware configuration of the space management server 5.

The space management server 5, which is an example of the information processing apparatus, includes a control unit 101 that controls the operation of the entire space management server 5, a hard disk drive 102 storing data, such as management data, and a network interface 103 that performs communication via a local area network (LAN) cable, for example.

The control unit 101 includes a central processing unit (CPU) 111, which is an example of a processor, a read only memory (ROM) 112 storing basic software and basic input output system (BIOS), and a random access memory (RAM) 113 used as a work area.

The CPU 111 may be a multi-core processor. The ROM 112 may be a rewritable non-volatile semiconductor memory. The control unit 101 is a computer.

The hard disk drive 102 is a device that reads and writes data from and into a non-volatile storage medium coated with a magnetic material on the surface of a disc-shaped substrate. The non-volatile storage medium may be a semiconductor memory or magnetic tape.

The space management server 5 also includes an input device, such as a keyboard and a mouse, and a display device, such as a liquid crystal display, as necessary.

The control unit 101, the hard disk drive 102, and the network interface 103 are connected to each other via a bus 104 and a signal line, which is not shown.

A program to be executed by the CPU 111 may be stored in a computer-readable recording medium, such as a magnetic recording medium (magnetic tape and a magnetic disk, for example), an optical recording medium (an optical disc, for example), a magneto-optical recording medium, and a semiconductor memory, and then be provided to the space management server 5.

A program to be executed by the CPU 111 may be provided to the space management server 5 by using a communication medium, such as the Internet.

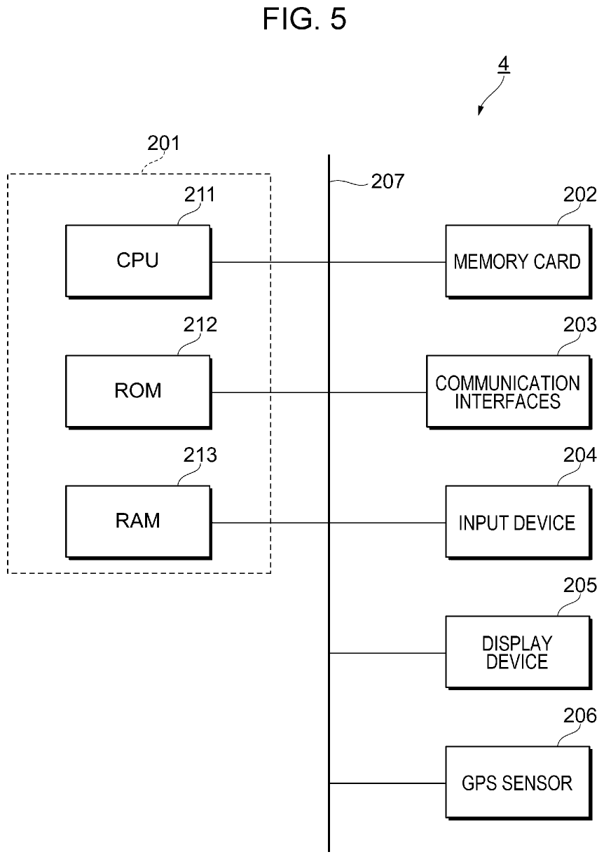

FIG. 5 is a block diagram illustrating an example of the hardware configuration of a user terminal 4. The hardware configuration in FIG. 5 is a configuration when the user terminal 4 is a smartphone.

The user terminal 4 includes a control unit 201 that controls the operation of the entire user terminal 4, a memory card 202 storing various types of data, various communication interfaces 203 compliant with wireless communication standards, an input device 204, such as a touch sensor, a display device 205, such as a liquid crystal display or an organic electroluminescence (EL) display, and a global positioning system (GPS) sensor 206.

The control unit 201 includes a CPU 211, a ROM 212 storing firmware and BIOS, for example, and a RAM 213 used as a work area. The CPU 211 may be a multi-core processor. The ROM 212 may be a rewritable non-volatile semiconductor memory.

The communication interfaces 203 include an interface for connecting to a mobile communication system and an interface for connecting to a wireless LAN.

The GPS sensor 206 is a sensor that locates the user terminal 4 by receiving radio waves from GPS satellites. Information about the latitude, longitude, and altitude output from the GPS sensor 206 determines the current position of the user terminal 4. The GPS sensor 206 may cover the function of an indoor positioning system.

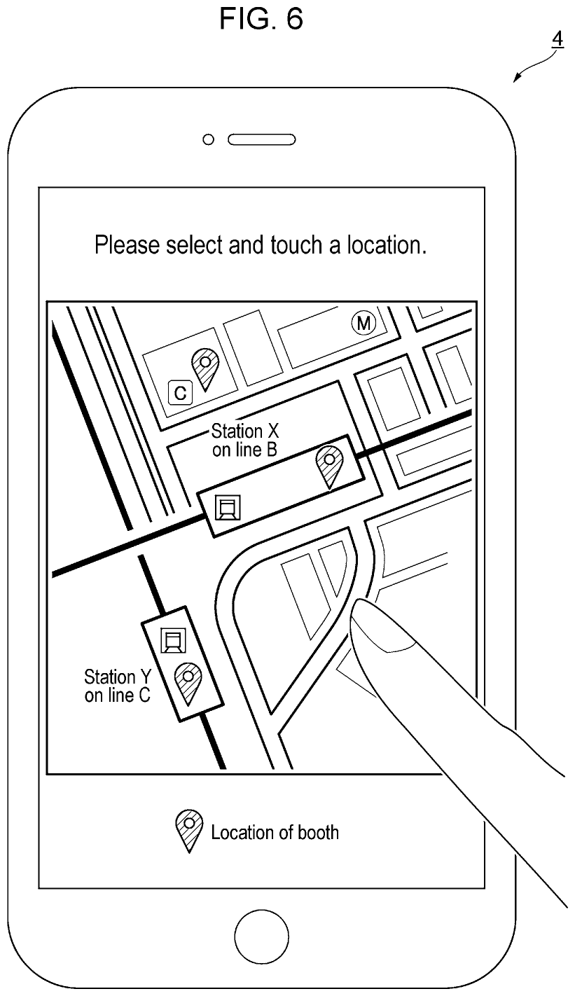

FIG. 6 illustrates an example of a display screen displayed on a user terminal 4 when a user reserves a booth 80.

On the display screen in FIG. 6, a map is shown, and multiple locations where booths 80 are installed are displayed on this map.

When reserving a booth 80, the user is instructed to choose a location from the multiple locations on the map. Instead of the display mode shown in FIG. 6, multiple locations of booths may be displayed in a list, and the user may select a location from the list.

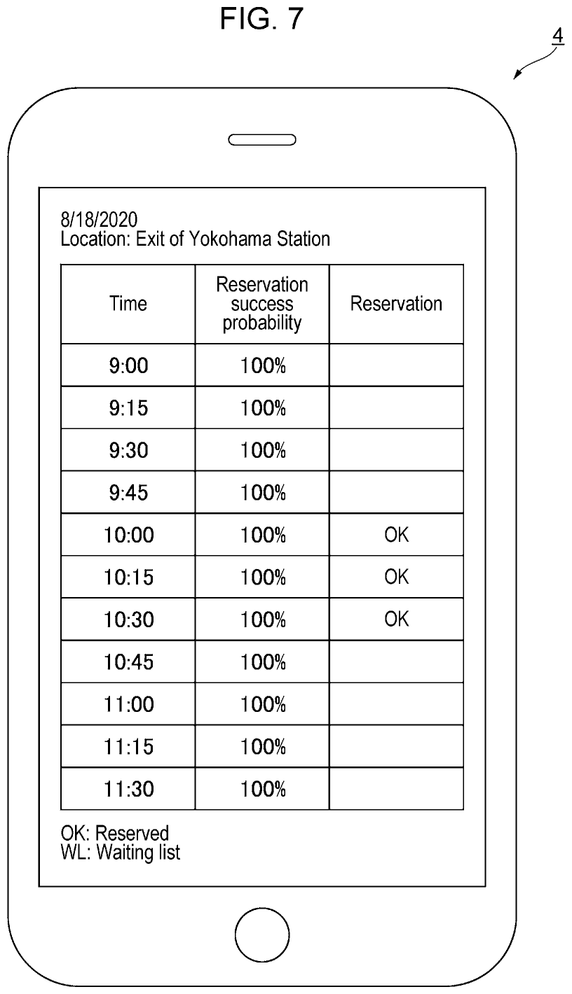

When the user has selected a location, the availability situation at the selected location per unit time, such as per 15 minutes, is displayed on the user terminal 4, as shown in FIG. 7.

Details of the display screen on the user terminal 4 will be discussed later.

The user operates the display screen and specifies a reservation time for the selected booth 80 and presses a setting button (not shown).

The space management server 5 executes reservation fixing processing.

More specifically, the space management server 5 executes reservation fixing processing by receiving information about the location and the reservation time of the booth 80 and registering this information in the hard disk drive 102 (see FIG. 4). The result is then sent to the user terminal 4 to inform the user that the reservation is fixed.

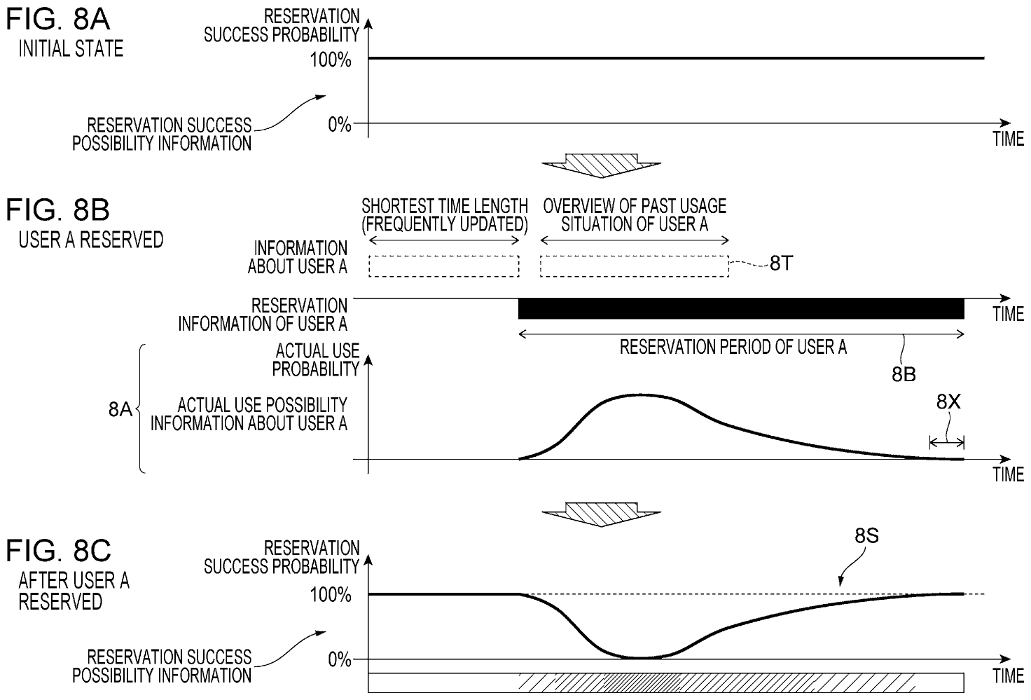

FIGS. 8A through 8C illustrate an example of processing executed by the CPU 111 of the space management server 5. More specifically, FIGS. 8A through 8C show a procedure of processing executed by the CPU 111 when generating the above-described display screen to be displayed on the user terminal 4.

In the exemplary embodiment, to generate a display screen to be displayed on the user terminal 4, the CPU 111 determines information about the possibility that a user having reserved a booth 80 will actually use the booth 80 (hereinafter such information will be called actual use possibility information).

A graph 8A in FIG. 8B shows actual use possibility information that a user A having reserved a booth 80 will actually use it.

The time period reserved by the user A is indicated by the double-headed arrow 8B in FIG. 8B. The CPU 111 determines the actual use possibility information about the user A in this time period. More specifically, as the actual use possibility information, the CPU 111 determines the probability of the user A using the booth 80 per unit time.

The CPU 111 identifies the past usage situation where the user A has used booths 80 and determines actual use possibility information (actual use probability) based on this past usage situation.

Booths 80 indicated in the past usage situation are not necessarily the booth 80 reserved by the user A and include booths 80 placed at multiple locations used by the user in the past.

An overview of the past usage situation of the user A is described in the broken-line frame 8T in FIG. 8B (an actual description is not shown).

In this example, the past usage situation of the user A shows that the user A often arrives late and often leaves a booth 80 in the second half of a reservation period.

Based on such a past usage situation, the CPU 111 determines, as actual use possibility information, that the user A is more likely to use a booth 80 in the middle stage of the first half of a reservation period and is less likely to use the booth 80 in the second half of the reservation period, as illustrated in the graph 8A in FIG. 8B.

The CPU 111 may determine actual use possibility information based on situation information, which is information about the situation of a user having reserved the booth 80.

An example of the situation information is position information about the user A. The CPU 111 obtains position information about the user A and determines actual use possibility information based on this position information.

The position information about the user A can be obtained from the GPS sensor 206 (see FIG. 5) provided in the user terminal 4 of the user A.

For example, based on traffic information, the CPU 111 determines the shortest time length required to reach the location of the booth 80 from the position of the user A indicated by the position information, and also determines the remaining time length from the current time to the reservation start time.

If the shortest time length is longer than the remaining time length, the CPU 111 judges that the user A will be late and that the booth 80 will not be used during a time length from the reservation start time until the time of the arrival of the user A.

In this case, the CPU 111 may determine, as actual use possibility information, that the actual use probability in the first half of the reservation period is 0%.

Other examples of the situation information are information about the job progress situation of the user A, information about the health condition of the user A, and information about the transportation used by the user A.

If information about the job progress situation of the user A indicates that the user A is behind schedule, the CPU 111 may determine, as actual use possibility information, that the probability of the user A using the booth 80 will be low in the first half of the reservation period or that the probability of the user A using the booth 80 will be low throughout the reservation period.

The information about the job progress situation may be obtained from information registered in a digital calendar (not shown) of the user A, for example.

If information about the health condition of the user A indicates that the user A is not in good condition, the CPU 111 may determine, as actual use possibility information, the probability of the user A using the booth 80 will be low throughout the reservation period.

Information about the health condition may be obtained from a watch-type electronic device (not shown) worn on the user A, for example.

If information about the transportation used by the user A indicates a transportation delay or traffic congestion, the CPU 111 may determine, as actual use possibility information, that the probability of the user A using the booth 80 will be low in the first half of the reservation period.

The CPU 111 may determine actual use possibility information based on attribute information about the user A.

As attribute information about the user A, the CPU 111 obtains information about whether the user A is a corporate user. If the user A is found to be a corporate user, the CPU 111 may determine, as actual use possibility information, that the probability of the user A using the booth 80 will be low throughout the reservation period.

A corporate user is more likely to cancel at the last minute than a private user, and the actual use probability tends to become low.

The CPU 111 thus determines, as actual use possibility information, that the probability of the user A using the booth 80 will be low throughout the reservation period.

In contrast, if the user A is found to be a private user, the CPU 111 determines, as actual use possibility information, that the probability of the user A using the booth 80 will be high.

As attribute information about the user A, the CPU 111 may obtain information about the gender and age of the user A, for example.

Based on the information about the gender and age of the user A, the CPU 111 obtains information about the tendency to use the booth 80 by the same gender as the user A and/or by the same generation as the user A.

Based on the information about the tendency to use the booth 80, the CPU 111 determines actual use possibility information. If the information about the tendency to use the booth 80 by the same generation as the user A indicates that they tend to arrive late, the CPU 111 may determine, as actual use possibility information, that the probability of the user A using the booth 80 will be low in the first half of the reservation period.

The CPU 111 may determine actual use possibility information based on information about a reservation made by the user A for the booth 80. Information about a reservation is the time and date of the reservation made by the user A for the booth 80.

In this case, the CPU 111 determines actual use possibility information based on information about the reservation time and date.

More specifically, if the reservation time is early in the morning or very late at night, which means that a cancellation of the reservation is likely to occur, the CPU 111 may determine, as actual use possibility information, that the probability of the user A using the booth 80 is low.

As the information about the reservation time and date, the CPU 111 may obtain information about the weather at the time and on the date of the reservation and determine actual use possibility information based on this information about the weather.

More specifically, if the information about the weather at the time and on the date of the reservation indicates that it will be likely to rain or snow, the CPU 111 may determine, as actual use possibility information, that the probability of the user A using the booth 80 will be low at the beginning of the reservation period or throughout the reservation period.

If the information about the weather at the time and on the date of the reservation indicates that the temperature will be high (very hot day), the CPU 111 may determine, as actual use possibility information, that the probability of the user A using the booth 80 will be high in the second half of the reservation period.

In the exemplary embodiment, an air-conditioning device (not shown) is installed in each booth 80. Even if the outside temperature is high, the temperature inside the booth 80 is kept low.

The user A is thus likely to remain in the booth 80. The CPU 111 may determine, as actual use possibility information, that the probability of the user A using the booth 80 will be high in the second half of the reservation period.

The CPU 111 may determine actual use possibility information based on information about what the user A has specified.

More specifically, if the user A has specified that a reservation made for the booth 80 is provisional, the CPU 111 may determine, as actual use possibility information, that the probability of the user A using the booth 80 will be low.

Details of a provisional reservation for a booth 80 will be discussed later.

As described above, in the exemplary embodiment, the CPU 111 determines actual use possibility information about the probability of the user A actually using the booth 80.

In other words, for the time slots reserved by the user A, the CPU 111 determines a time slot in which the probability of the user A using the booth 80 is likely to be high and a time slot in which the probability of the user A using the booth 80 is likely to be low.

In the exemplary embodiment, based on the actual use possibility information, the CPU 111 also determines information about the probability of another user on the waiting list being able to use the booth 80 due to a cancellation by the user A. This probability will be called reservation success probability, and information about the reservation success probability will be called reservation success possibility information.

In other words, based on the actual use possibility information, the CPU 111 determines information about the probability of another user on the waiting list being able to use the booth 80.

“Being on the waiting list” is a reservation mode in which a reservation is already fixed for a user to use an object and another reservation is yet made for this object (hereinafter called an additional reservation) and when the fixed reservation is canceled, the additional reservation is switched to a fixed reservation.

FIG. 8C is a diagram showing reservation success possibility information determined by the CPU 111.

The CPU 111 determines reservation success possibility information, based on the actual use possibility information shown in the graph 8A in FIG. 8B.

More specifically, the CPU 111 determines reservation success possibility information as shown in FIG. 8C by subtracting actual use possibility information (actual use probability) per unit time from 100%.

As shown in the graph 8A in FIG. 8B, the actual use possibility (actual use probability) of the user A using the booth 80 in the first half of the reservation period of the user A is high.

Hence, as indicated by a graph 8S in FIG. 8C, the reservation success probability in the first half of the reservation period of the user A is low, that is, the probability of another user on the waiting list being able to use the booth 80 is low.

In contrast, the probability of the user A using the booth 80 in the second half of the reservation period of the user A is low. Hence, as indicated by the graph 8S in FIG. 8C, the reservation success probability in the second half of the reservation period of the user A becomes high, that is, the probability of another user on the waiting list being able to use the booth 80 becomes high.

More specifically, the value represented by the reservation success possibility information becomes high in the second half of the reservation period of the user A. In other words, the probability of another user on the waiting list being able to use the booth 80 becomes high in the second half of the reservation period.

FIG. 8A illustrates reservation success possibility information before the user A makes a reservation for the booth 80.

The reservation success possibility information shown in FIG. 8A does not indicate the possibility of another user on the waiting list being able to use the booth 80, but the possibility of the user A successfully making a reservation for the booth 80.

In this example, no reservation has been made for the booth 80 when the user A makes a reservation. Accordingly, the value represented by the reservation success possibility information is 100% in any time slot. That is, the user A is able to reserve and use the booth 80 at any time.

In contrast, after the user A has made a reservation, the value represented by the reservation success possibility information in the time period reserved by the user becomes smaller, as shown in FIG. 8C.

More specifically, in the exemplary embodiment, the reservation success possibility information shown in FIG. 8C is determined by subtracting the actual use probability indicated by the graph 8A in FIG. 8B from the reservation success probability shown in FIG. 8A. As shown in FIG. 8C, in the time period reserved by the user A, the value represented by the reservation success possibility information becomes small.

Especially in the first half of the reservation period of the user A, the user A is highly likely to use the booth 80, and the reservation success probability is accordingly low in the first half of the reservation period.

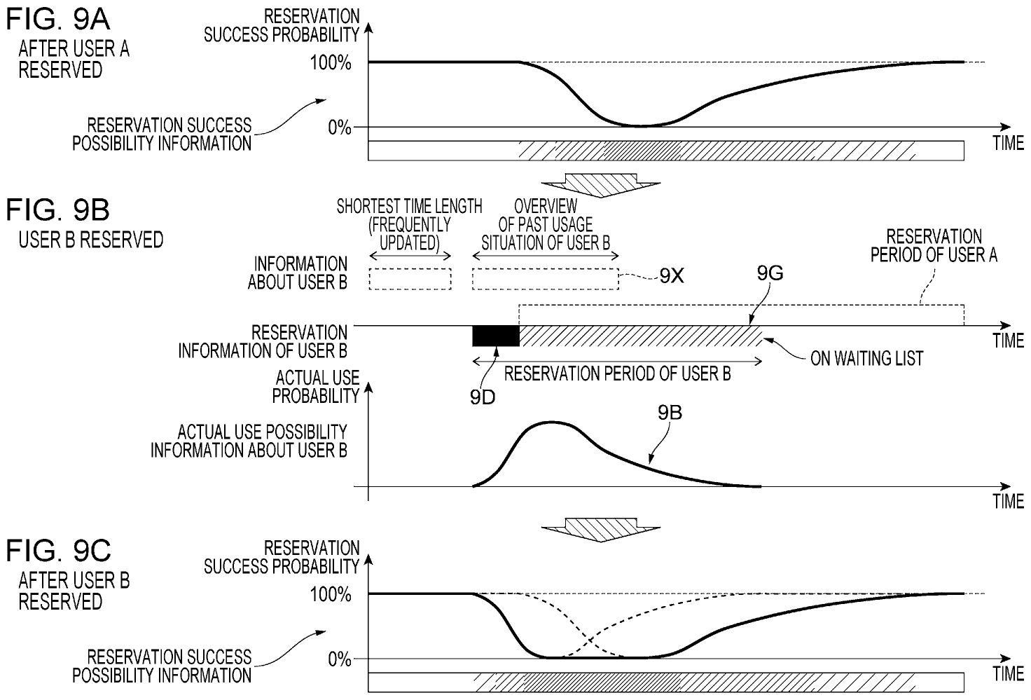

FIGS. 9A through 9C illustrate a procedure of processing executed by the CPU 111 when a user B makes a reservation after the user A.

FIG. 9A illustrates reservation success possibility information after the user A has reserved the booth 80 and before the user B reserves the booth 80. To put it another way, the reservation success possibility information shown in FIG. 9A is the same as that in FIG. 8C.

FIG. 9B illustrates actual use possibility information about the possibility of the user B using the booth 80 in a time slot to be reserved.

In this example, as in the case of the user A, an overview of the past usage situation of the user B described in the broken-line frame 9X indicates that the possibility of the user B using the booth 80 in the first half of the reservation period is high (an actual description is not shown).

In this case, as illustrated in a graph 9B in FIG. 9B, the actual use possibility information shows that the actual use probability of the user B using the booth 80 in the first half of the reservation period is high, while that in the second half of the reservation period is low.

In this example, the user B has made a reservation in a time period before that of the user A, as indicated by the solid time slot 9D. The user B has also made an additional reservation on the waiting list in the time period of the user A, as indicated by the hatched time slots 9G.

FIG. 9C illustrates reservation success possibility information after the user B has made a reservation.

The CPU 111 determines the actual use possibility information about the user B, and then determines reservation success possibility information as shown in FIG. 9C by subtracting the actual use possibility information (actual use probability) about the user B represented by the graph 9B from the reservation success possibility information shown in FIG. 9A.

In this example, since the user B has made the reservation as well as the user A, the value represented by the reservation success possibility information becomes low over a longer time period, as shown in FIG. 9C. In other words, the probability of another user on the waiting list being able to use the booth 80 is low over a longer time period.

Particularly during the time period for which both of the user A and the user B have reserved the booth 80 (time period for which the user B is on the waiting list), the reservation success probability is extremely low.

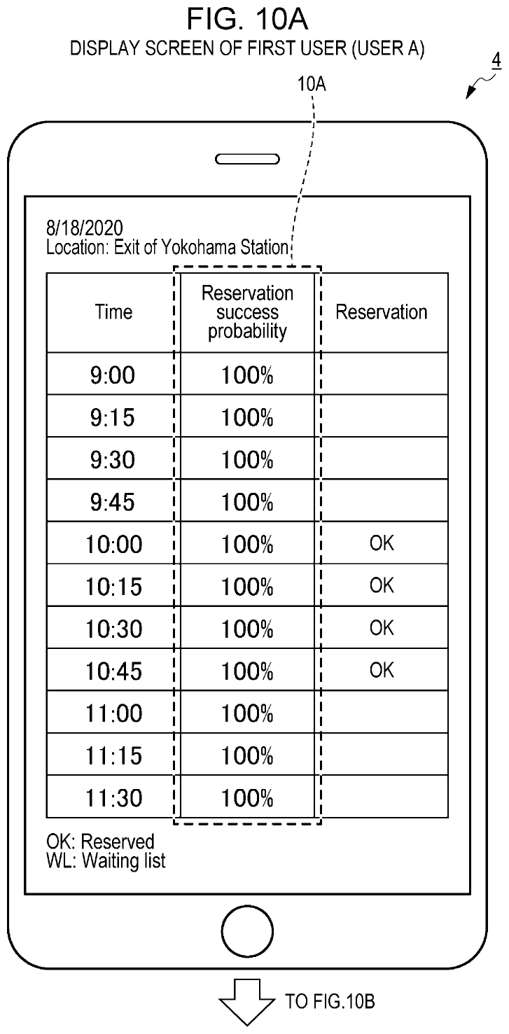

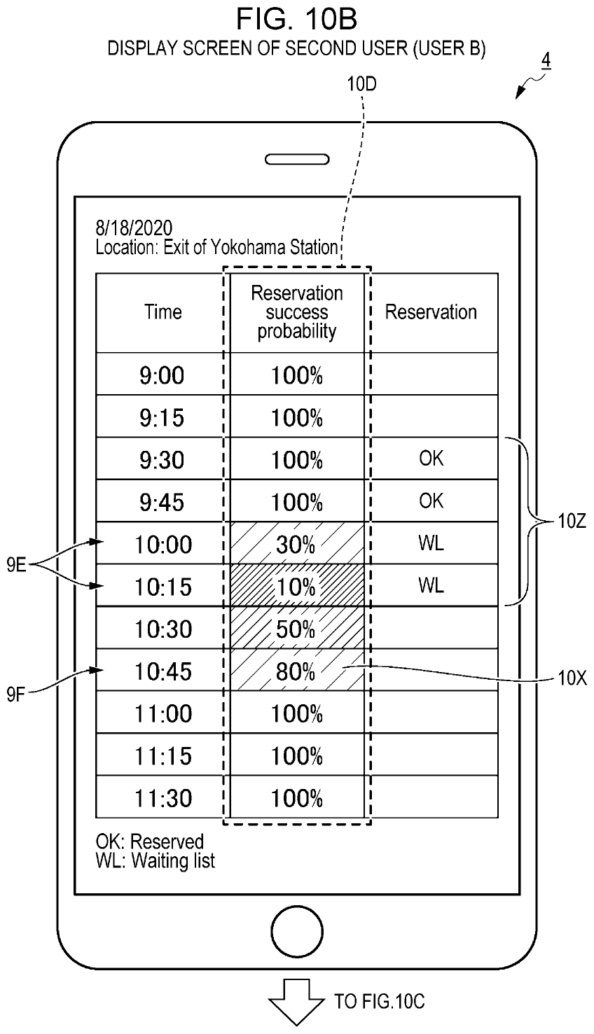

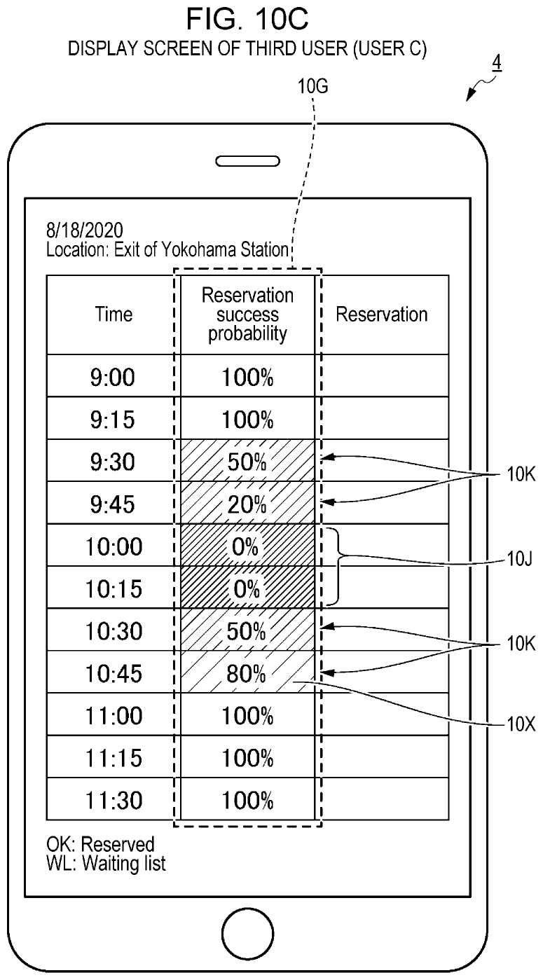

FIGS. 10A through 10C illustrate examples of display screens displayed on user terminals 4 when the corresponding users make a reservation for the booth 80.

As a result of the above-described processing, reservation success possibility information is generated and is reflected on each of the display screens on the user terminals 4 shown in FIGS. 10A through 10C.

FIG. 10A illustrates a display screen on the user terminal 4 of the user A when the user A makes a reservation for the booth 80.

Reservation success possibility information is displayed in a reservation success probability field 10A. In this example, no reservation has been made when the user A makes a reservation, and the reservation success probability in any time slot is 100%, that is, the probability of the user A successfully making a reservation is 100% in any time slot.

The user A then operates the display screen to make a reservation. In this example, the user A has made a reservation for the booth 80 in four time slots starting at “10:00”, “10:15”, “10:30”, and “10:45”. In the exemplary embodiment, “OK” is input in the reservation field to indicate that a reservation is fixed.

FIG. 10B illustrates a display screen on the user terminal 4 of the user B when the user B makes a reservation for the booth 80.

Reservation success possibility information indicating the probability of the user B being able to make a reservation is displayed in a reservation success probability field 10D. The reservation success probability field 10D shows that the reservation success probability is different depending on the time slot.

More specifically, as discussed above, the possibility of the user A using the booth 80 in the first half of the reservation period of the user A is high, and the reservation success probabilities in the time slots corresponding to the first half of the reservation period are thus low.

The reservation success probability in a time slot 9E starting at “10:00” is 30%, while that in a time slot 9E starting at “10:15” is 10%.

In contrast, in time slots without any reservation and those in which the user A is unlikely to use the booth 80, the reservation success probabilities are high.

In a time slot in which the user A has not made a reservation, the reservation success probability is 100%. In a time slot 9F in which the user A is unlikely to use the booth 80, the reservation success probability is 80%.

The user B checks the display screen shown in FIG. 10B and makes a reservation.

In this example, the user B has made a reservation for the booth 80 in four time slots starting at “09:30”, “09:45”, “10:00”, and “10:15”.

For the time slots starting at “09:30” and “09:45”, the reservation success probability is 100%, and the reservations in these time slots are fixed.

In contrast, for the time slots starting at “10:00” and “10:15”, reservations have been made by the user A, and the user B is on the waiting list. To put it another way, for the time slots starting at “10:00” and “10:15”, the reservation success probability is lower than 100%, and the user B is on the waiting list.

In the exemplary embodiment, the probability of the user B being able to make a reservation is displayed on the user terminal 4 of the user B. The user B checks this reservation success probability and then decides whether to make a reservation. When a cancellation seems unlikely to occur, the user B may decide not to make a reservation.

FIG. 10C illustrates a display screen on the user terminal 4 of a user C when the user C makes a reservation for the booth 80.

Reservation success possibility information indicating the probability of the user C being able to make a reservation is displayed in a reservation success probability field 10G. The reservation success probability field 10G shows that the reservation success probability is different depending on the time slot.

When the user C makes a reservation, the reservations by the user A and those by the user B have already been made. In time slots 10J with the reservations made by both of the user A and the user B, the reservation success probability is 0%.

In contrast, in time slots without any reservation, the reservation success probability is 100%, and in time slots 10K in which only one of the user A and the user B has made a reservation, the reservation success probability is higher than those in which both of the user A and the user B have made reservations.

The user C checks the reservation success probability shown in FIG. 10C and then decides whether to make a reservation.

In the exemplary embodiment, on the display screens shown in FIGS. 10B and 10C, the color or the pattern of a background 10X or the density of the color of the background 10X of the reservation success probability field is changed in accordance with the degree of the reservation success probability.

This allows a user to intuitively understand how much the user has a chance of getting a reservation by cancellation, compared with when the color of the background 10X of the display field is white.

In the exemplary embodiment, when a user makes a reservation for the booth 80 over multiple time slots, the CPU 111 determines actual use possibility information (actual use probability) for each time slot. In other words, the CPU 111 determines actual use possibility information per unit time (per 15 minutes in the exemplary embodiment).

Based on the actual use possibility information per unit time, the CPU 111 determines reservation success possibility information (the probability of a user on the waiting list being able to make a reservation) per unit time.

In this manner, the reservation success probability per unit time (per 15 minutes) is displayed, as shown in FIGS. 10B and 10C.

Usually, a user is uncertain whether he/she can arrive in a reserved booth 80 on time or whether he/she can finish work before the reservation end time. For such reasons, the user tends to reserve a booth 80 for a longer time than actually required. Accordingly, the booth 80 may not be actually used at the beginning of or in the second half of a reservation period.

In contrast, in the exemplary embodiment, a user on the waiting list is encouraged to make a reservation in a time slot in which the booth 80 is unlikely to be used. If a reservation for the booth 80 in a certain time slot is canceled, the booth 80 is more likely to be occupied by another user. The occupancy rate of the booth 80 is thus raised.

In the exemplary embodiment, reservation success possibility information (the probability of a user on the waiting list being able to make a reservation) is displayed. As an alternative to such a display mode, information merely indicating whether a reservation has been made by someone else may be displayed on the display screen of a user terminal 4.

In this display mode, however, if a reservation is already made, a user on the waiting list is less likely to expect that there will be a cancellation and pays less attention to the occurrence of a cancellation. Even if there is actually a cancellation, a user on the waiting list may not realize it and not use the booth 80. The occupancy rate of the booth 80 is thus lowered.

In contrast, in the exemplary embodiment, reservation success possibility information is displayed. If the probability of being able to make a reservation is high, a user on the waiting list is more likely to expect that there will be a cancellation.

When there is actually a cancellation, a user on the waiting list is more likely to use the booth 80. The occupancy rate of the booth 80 is thus raised.

As another example of processing, for a time slot in which actual use possibility information (actual use probability) is 0% or a time slot in which actual use possibility information (actual use probability) is lower than a predetermined threshold, a reservation may be canceled.

Alternatively, for such a time slot, a message may be sent to the user to suggest that the user cancel the reservation.

That is, for a time slot in which actual use possibility information (actual use probability) is lower than the predetermined threshold, such as a time slot indicated by the double-headed arrow 8X in FIG. 8B, the CPU 111 cancels the reservation or output information for suggesting that the user cancel the reservation.

When such information is output, a message suggesting that the user cancel the reservation is displayed on the user terminal 4.

Such a message may be a message instructing the user to cancel the reservation, such as “Please cancel the reservation.” or a message suggesting that the user cancel the reservation, such as “If you do not cancel, you will be charged even if you do not use the booth”.

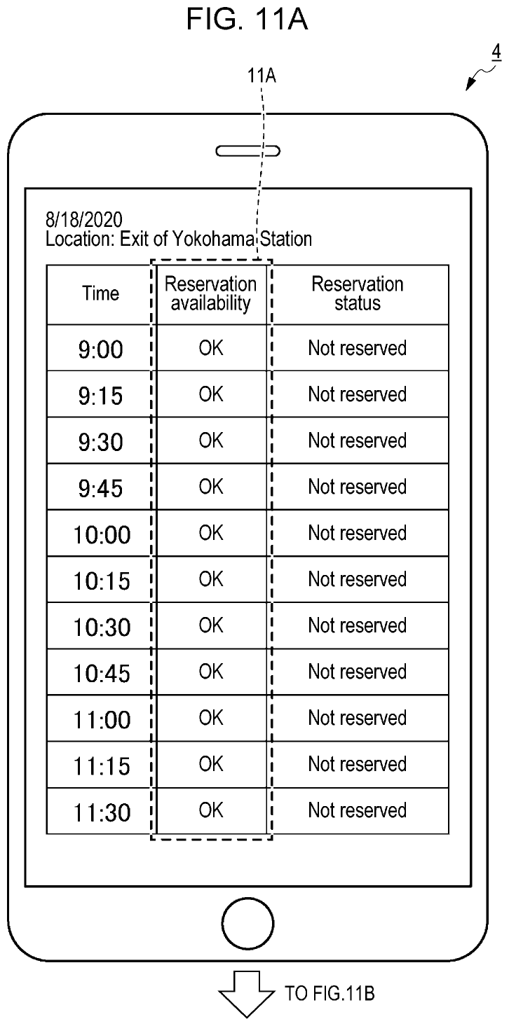

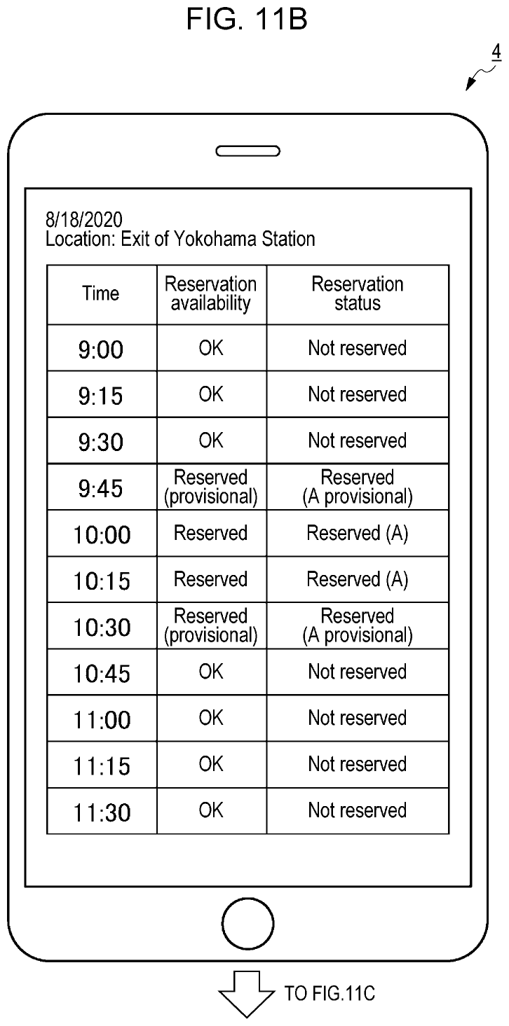

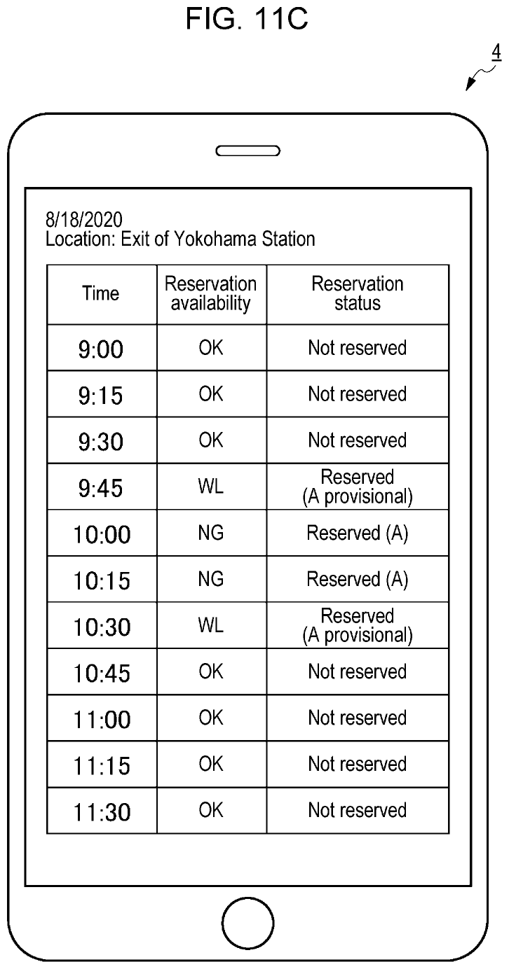

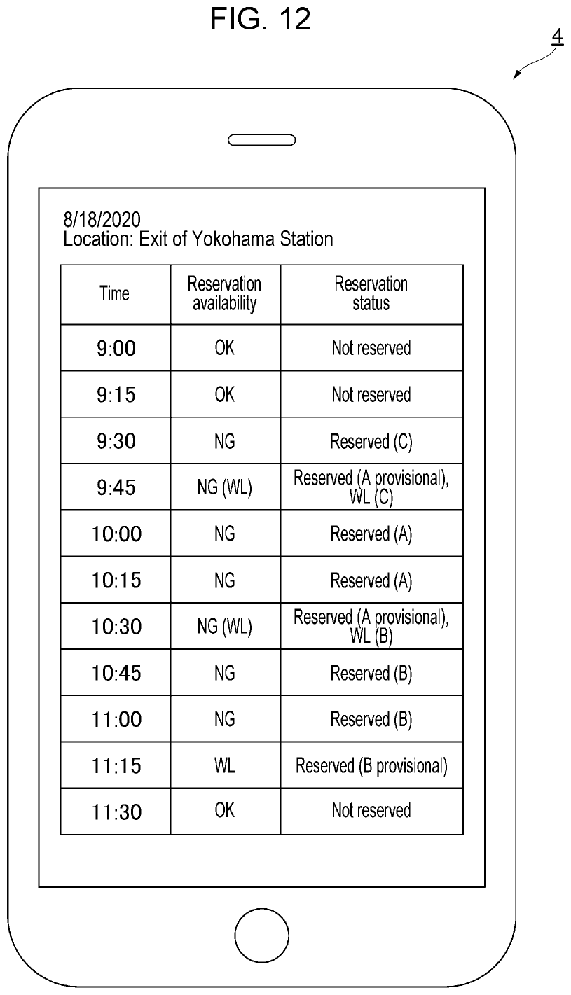

FIGS. 11A through 12 illustrate other display examples on user terminals 4.

FIG. 11A illustrates a display screen on the user terminal 4 of the user A when the user A makes a reservation for the booth 80.

On this display screen, the reservation availability in each time slot is indicated. More specifically, in a reservation availability field 11A, “OK” or “NG” is input to indicate whether a user can make a reservation.

“OK” means that the user A can make a reservation, while “NG” means that the user A cannot make a reservation.

In this example, no reservation has been made when the user A makes a reservation, and the user A can make a reservation in any time slot. More specifically, “OK” is input in all the time slots to indicate that the user A can make a reservation.

In a reservation status field on the right side of this display screen, the reservation status is displayed. In this example, no reservation has been made, and “Not reserved” is indicated in the reservation status field.

FIG. 11B illustrates a display screen after the user A has made a reservation for the booth 80 in four time slots starting at “9:45”, “10:00”, “10:15”, and “10:30”.

For the two time slots starting at “10:00”, “10:15”, a regular reservation is made. “Reserved” is input in the reservation availability field, and “Reserved (A)” is input in the reservation status field to indicate that a reservation is made by the user A.

For the two time slots starting at “9:45”, “10:30”, a provisional reservation is made by the user A.

In this case, “Reserved (provisional)” is input in the reservation availability field, while “Reserved (A provisional)” is input in the reservation status field.

It is highly unlikely that the booth 80 will be used by a provisional reservation.

As discussed above, usually, a user is uncertain whether he/she can arrive in a reserved booth 80 on time or whether he/she can finish work before the reservation end time. For such reasons, the user tends to reserve the booth 80 for a longer time than actually required and may make a provisional reservation immediately before the actual start time and immediately after the actual end time. The need to use the booth 80 by this provisional reservation is smaller than that by a regular reservation.

In the exemplary embodiment, a user is instructed to specify whether a reservation made by the user is provisional. If the reservation is provisional, information indicating that the reservation is provisional is registered.

For a time slot in which a provisional reservation is made, another user can be put on the waiting list to make an additional reservation.

In contrast, for a time slot in which a regular reservation is made, another user cannot be put on the waiting list to make an additional reservation.

In the exemplary embodiment, if a user has specified that the need to use a booth 80 by a reservation made by the user is small, another user can make an additional reservation for the booth 80. More specifically, for a time slot in which a user has specified that the need to use a booth 80 by a reservation made by the user is small, another user can make an additional reservation.

In contrast, if the user has not specified that the need to use a booth 80 by a reservation made by the user is small, another user is not allowed to make an additional reservation.

In the exemplary embodiment, a user voluntarily specifies whether a reservation made by the user is provisional. Alternatively, a query may be made to a user via the user terminal 4 about whether a reservation made by the user is provisional.

For example, a query may be made about whether a reservation made for the beginning or the end of the entire reservation period is provisional.

If the user has responded that a reservation in a certain time slot is provisional, information that the reservation is provisional is registered in this time slot to let another user make an additional reservation.

FIG. 11C illustrates a display screen to be checked by another user after the user A has made a reservation.

On this display screen, for the two time slots starting at “10:00” and “10:15” in which a regular reservation is made, “NG” is input in the reservation availability field to indicate that a user cannot be put on the waiting list to make an additional reservation.

For the two time slots starting at “10:00” and “10:15” with a regular reservation, “Reserved (A)” is input in the reservation status field to indicate that the user A has made a regular reservation.

For the two time slots starting at “9:45 and “10:30” in which a provisional reservation is made, “WL” is input in the reservation availability field to indicate that a user can be put on the waiting list to make an additional reservation.

For the two time slots starting at “9:45 and “10:30” with a provisional reservation, “Reserved (A provisional)” is input in the reservation status field to indicate that the user A has made a provisional reservation.

In the processing example in FIGS. 11A through 11C, actual use possibility information about the possibility of the user A actually using the booth 80 is reflected.

More specifically, in this processing example, information about whether a reservation is provisional serves as actual use possibility information.

In the exemplary embodiment, for a time slot in which information that a reservation is provisional is input, the possibility of the user A actually using the booth 80 is low.

In the exemplary embodiment, on the display screen in FIG. 11C, reservation success possibility information is reflected. More specifically, “WL” input in the reservation availability field indicates the reservation success possibility information, and “Reserved (A provisional)” input in the reservation status field also indicates the reservation success possibility information.

This makes a user recognize that, for a time slot with “WL” and “Reserved (A provisional)”, the user may be put on the waiting list and have a chance of getting a reservation.

FIG. 12 illustrates a display screen after a user B and a user C have operated the display screen in FIG. 11C.

The display screen in FIG. 12 shows that the user C on the waiting list has made a reservation in the time slot starting at “09:45”, and “NG (WL)” is input in the reservation availability field. “NG (WL)” means that no more user can be put on the waiting list to make an additional reservation.

For the time slot starting at “09:45” in which the user C on the waiting list has made a reservation, “WL (C)” is displayed next to “Reserved (A provisional)” in the reservation status field. “WL (C)” means that the user C on the waiting list has made an additional reservation.

The display screen in FIG. 12 also shows that, for the time slot starting at “10:30”, the user B on the waiting list has made a reservation, and “NG (WL)” is input in the reservation availability field. No more user can be put on the waiting list to make an additional reservation for this time slot.

For the time slot starting at “10:30” in which the user B on the waiting list has made a reservation, “WL (B)” is displayed next to “Reserved (A provisional)” in the reservation status field. “WL (B)” means that the user B on the waiting list has made an additional reservation.

In this processing example, only one user can be put on the waiting list to make an additional reservation in each time slot.

As discussed above, after the user B or the user C has made an additional reservation for a time slot, no more user can be put on the waiting list for this time slot.

### Other Exemplary Embodiments

In the exemplary embodiment, a user reserves a booth 80 before the use. It may also be determined whether a user is allowed to cancel a reservation for a booth 80.

If a predetermined condition is satisfied, it may be determined that a user is not allowed to cancel the reservation.

For example, if a user tries to cancel a reservation after a predetermined time, such as within five minutes before the reservation start time, and if no other user is on the waiting list, the user may not be allowed to cancel the reservation.

In other words, for a time slot already reserved by a user, if no other user has made an additional reservation and if a predetermined time has already elapsed, the user may not be able to cancel the reservation.

In this case, if a cancellation is accepted, another user to use the booth 80 may not be found immediately, and the booth 80 becomes unoccupied, which lowers the occupancy rate of the booth 80.

In contrast, if a cancellation is not accepted as discussed above, the user reserved the booth 80 is highly likely to use it. This enhances the occupancy rate of the booth 80.

Information about the cancellation status may be presented to a user waiting near (in front of) a booth 80 on a display or via a speaker (not shown) installed on the booth 80.

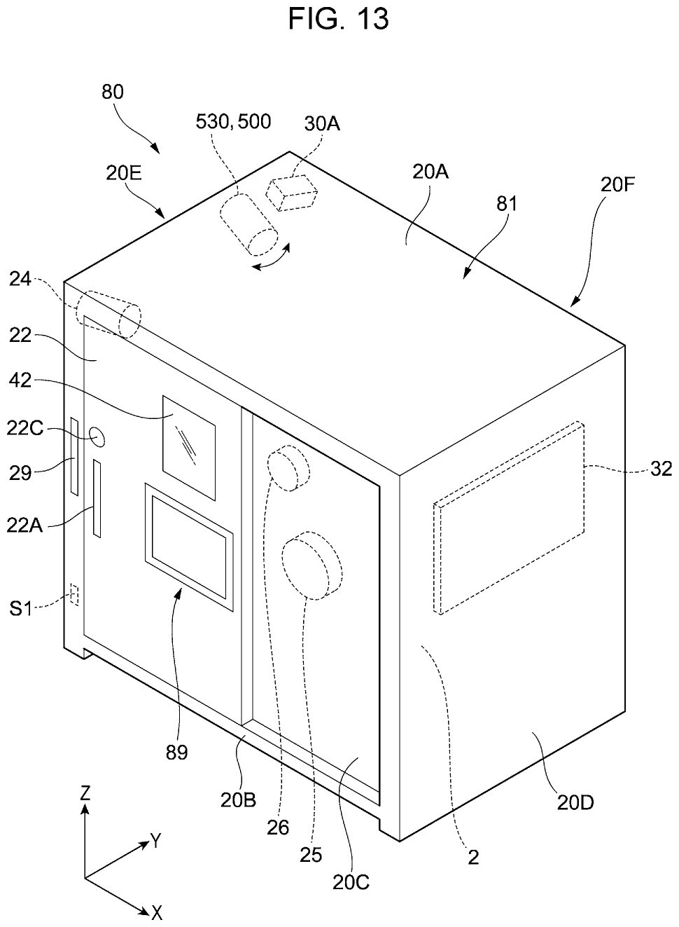

For example, as shown in FIG. 13, a display 89 or a speaker (not shown) may be installed outside the booth 80 and information about the cancellation status may be presented on the display 89 or via the speaker.

For example, information indicating that there has been no cancellation may be displayed on the display 89 for a user waiting near the booth 80.

In the exemplary embodiment, if the reservation success probability is 80%, a user on the waiting list may wait near the booth 80 until his/her reservation start time arrives.

A user inside the booth 80 may decide to continue using the booth 80 without canceling his/her reservation.

In this case, information indicating that there has been no cancellation may be displayed on the display 89 or via the speaker for a user waiting near the booth 80.

For example, if the user inside the booth 80 has not canceled his/her reservation when a predetermined time arrives, such as five minutes before the reservation start time of a user on the waiting list, information that there has been no cancellation may be displayed on the display 89 or via the speaker.

Instead of the display 89 or the speaker installed on the booth 80, the user terminal 4 of a user waiting near the booth 80 may be used to inform the user that there has been no cancellation.

If reservations made by a user on the waiting list are only additional reservations, such additional reservations may not be accepted.

For example, if a user on the waiting list has made a reservation only in a single time slot and if this reservation is an additional reservation, this reservation may not be accepted.

If a user on the waiting list has made a reservation for consecutive time slots and if this reservation is an additional reservation, this reservation may not be accepted.

If a user on the waiting list merely makes an additional reservation, he/she may pay less attention to this reservation than to a regular reservation and may even forget that he/she has made this reservation. In this case, even if there is a cancellation, the user may not recognize it and not turn up in the booth 80. The booth 80 may not be used at all.

In contrast, if such an additional reservation is not accepted, the reservation mode allowed for a user is either a regular reservation only or a combination of a regular reservation and an additional reservation which are temporally consecutive. In such a reservation mode, when there is a cancellation, a user having made an additional reservation is more likely to turn up in the booth 80.

In other words, in the exemplary embodiment, an additional reservation made by a user in a time slot in which another user has already reserved may be accepted or not be accepted depending on the reservation mode of the user having made the additional reservation.

If this user makes an additional reservation in a certain time slot and also makes a regular reservation in a time slot without any reservation continued from or to this certain time slot, the additional reservation is accepted.

In contrast, if this user makes an additional reservation in a certain time slot and does not make a regular reservation in a time slot continued from or to this certain time slot or if the user makes an additional reservation in a certain time slot and makes another additional reservation in a time slot with another reservation continued from or to the certain time slot, the additional reservation is not accepted.

This will be explained below using a specific example. In the case of the reservation mode in time slots 10Z shown in FIG. 10B, a regular reservation and an additional reservation are made consecutively by the same user on the waiting list.

If this user manages to get a reservation by cancellation, he/she is likely to continue to use the booth 80 after the regular reservation. This enhances the occupancy rate of the booth 80 during the time slots after the regular reservation.

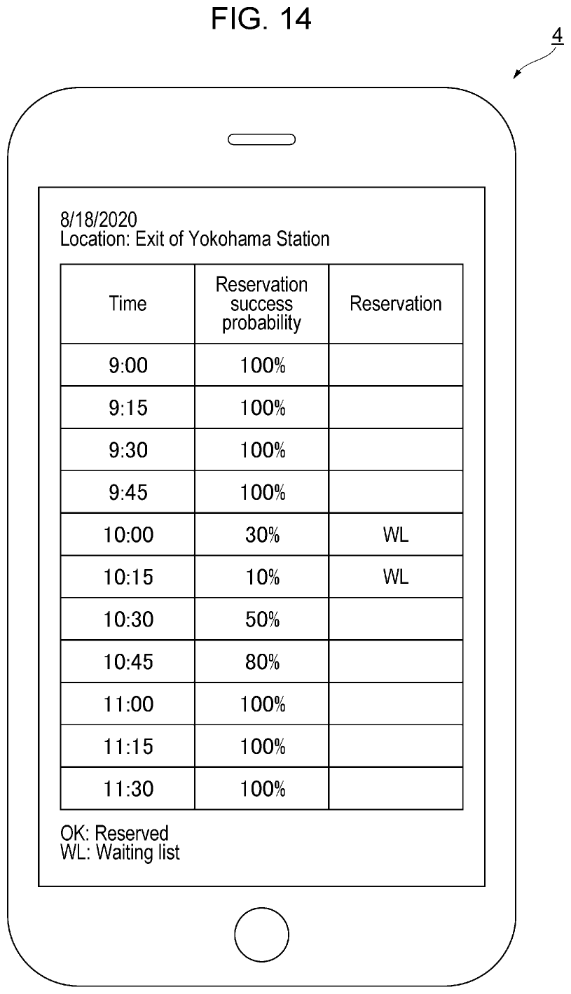

In contrast, in the case of the reservation mode shown in FIG. 14, a user has made only an additional reservation. The user is less likely to turn up in the booth 80 even if there is a cancellation.

A predetermined threshold may be used to restrict the number of users that can be put on the waiting list in each time slot. The predetermined threshold may be 1, for example.

In other words, in the exemplary embodiment, for a time slot already reserved by a user, another user is also able to make an additional reservation in this time slot. In this case, a predetermined threshold may be used to restrict the number of users that can make an additional reservation. The predetermined threshold may be 1, for example.

If many users are allowed to be on the waiting list in each time slot, the system becomes complicated. With a limited number of users on the waiting list, the system becomes less complicated.

If many users are allowed to be on the waiting list, a user on a lower position on the waiting list is less likely to pay attention to an additional reservation made by this user and may even forget that he/she has made the additional reservation. In this case, even if there is a cancellation, the user may not recognize it and not turn up in the booth 80 (no show).

If, as in the exemplary embodiment, the number of users allowed to make an additional reservation is restricted to the number represented by a predetermined threshold or smaller, an incident, such as a no show, is less likely to occur.

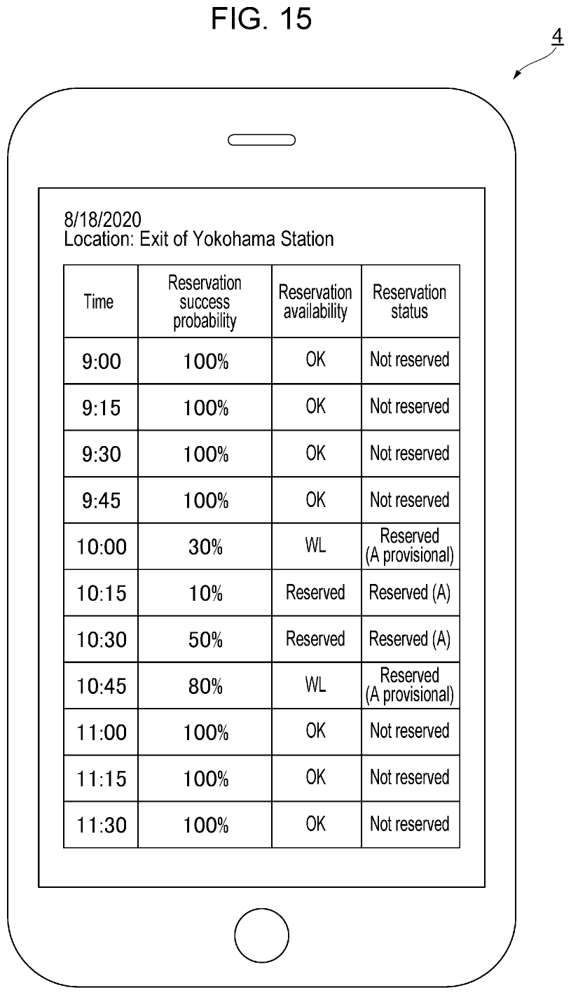

The display screen shown in FIG. 10B and that shown in FIG. 11C may be combined with each other and be displayed on the user terminal 4, as shown in FIG. 15.

On the display screen shown in FIG. 10B, the reservation success probability is displayed, while, on the display screen shown in FIG. 11C, information indicating whether a reservation is provisional is displayed.

On the display screen in FIG. 15, both of the reservation success probability and information indicating whether a reservation is provisional are displayed. This enables a user to have more information to decide whether to be on the waiting list.

The reservation success probability displayed in FIG. 15 may be determined by including the reservation availability information shown in FIG. 15.

To put it another way, the reservation success probability in FIG. 15 may be determined by including information indicating whether a reservation is provisional.

The reservation success probability in FIG. 15 has been determined based on the past usage situation of a user and/or the situation about the user. In addition to the past usage situation and the situation about a user, information indicating whether a reservation made by this user is provisional may be taken into consideration to determine the reservation success probability.

For a regular reservation, as well as for an additional reservation, the reservation success probability may be determined by using information regarding whether this reservation is provisional.

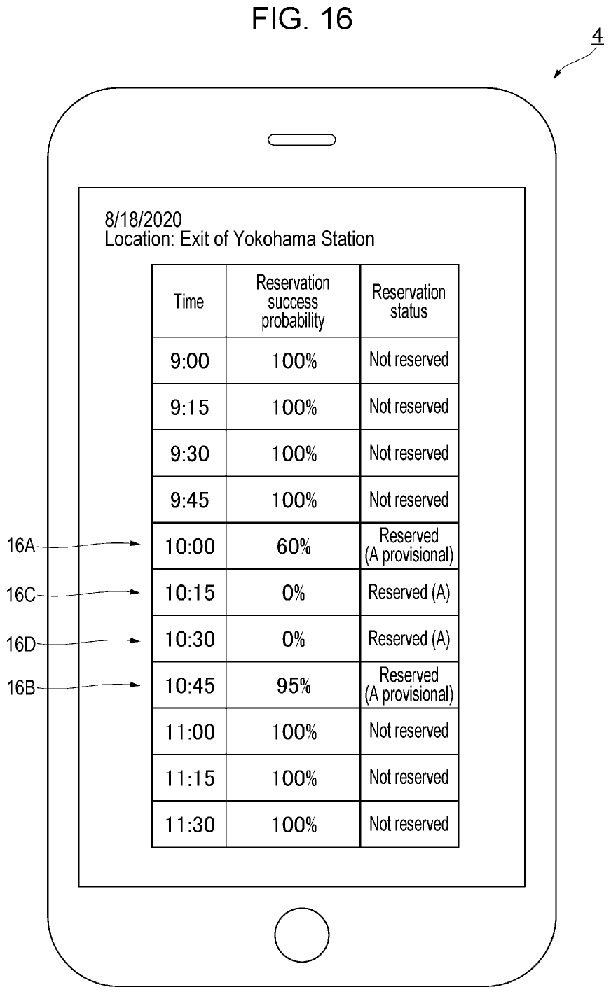

FIG. 16 illustrates a display screen when the reservation success probability is determined by including information regarding whether a reservation is provisional.

On this display screen, the reservation availability information indicating whether a reservation is provisional is not displayed. Information regarding whether a reservation is provisional is reflected in the reservation success probability.

On the display screen in FIG. 16, the reservation success probability in a time slot 16A is 60%. The reservation success probability in the same time slot on the display screen in FIG. 15 is 30% and is raised to 60% as a result of including information that the reservation is provisional.

On the display screen in FIG. 16, the reservation success probability in a time slot 16B is 95%. The reservation success probability in the same time slot on the display screen in FIG. 15 is 80% and is raised to 95% as a result of including information that the reservation is provisional.

On the display screen in FIG. 16, in time slots 16C and 16D in which a regular reservation is made, the reservation success probability is 0%.

As discussed above, in the exemplary embodiment, for a time slot in which a regular reservation is made, a user is not allowed to be on the waiting list to make an additional reservation. On this display screen, information that a user is not allowed to be on the waiting list is reflected in the reservation success probability, which is thus determined to be 0%.

The above-described functions may be nullified according to user's preference. For example, a user may operate a setting screen (not shown) displayed on the user terminal 4 to cancel a certain function.

More specifically, a function of displaying reservation success possibility information and/or a function of displaying information about whether a reservation is provisional may be nullified as a result of a user operating a display screen on the user terminal 4.

In the exemplary embodiment, a booth 80 (space 2) is an example of an object to be reserved. However, the object to be reserved is not limited to a booth 80 and may be any tangible or intangible object as long as it can be used by reservation.

An example of an intangible object is a service provided to a user.

An example of a tangible object is an object rented to a user. Specific examples of an object rented to a user for a limited period are rental cars, video, compact discs (CDs), digital versatile discs (DVDs), books, and skiing equipment.

Other examples are tickets for concerts, sport games, and movies and seats in transportation facilities, such as in trains.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system that executes processing for an object reserved by a user, comprising:
a processor configured to:
determine possibility information about a possibility that a first user having reserved the object will actually use the object.

2. The information processing system according to claim 1, wherein the processor is configured to determine the possibility information based on a past usage situation of the first user having used the object.

3. The information processing system according to claim 1, wherein the processor is configured to determine the possibility information based on situation information about a situation of the first user.

4. The information processing system according to claim 3, wherein the processor is configured to obtain position information about a position of the first user as the situation information and to determine the possibility information based on the position information.

5. The information processing system according to claim 1, wherein the processor is configured to determine the possibility information based on attribute information about an attribute of the first user.

6. The information processing system according to claim 1, wherein the processor is configured to determine the possibility information based on information about a reservation made by the first user for the object.

7. The information processing system according to claim 6, wherein the processor is configured to determine the possibility information based on information about a time and a date of the reservation made by the first user.

8. The information processing system according to claim 7, wherein the processor is configured to determine the possibility information based on information about weather at the time and on the date of the reservation made by the first user.

9. The information processing system according to claim 1, wherein the processor is configured to determine the possibility information based on information specified by the first user.

10. The information processing system according to claim 1, wherein the processor is configured to further determine a possibility that a second user other than the first user will be able to use the object, based on the possibility information.

11. The information processing system according to claim 1, wherein the processor is configured to cancel a reservation made by the first user for the object or to output information for suggesting that the first user cancel the reservation if the possibility indicated by the possibility information is lower than a predetermined threshold.

12. The information processing system according to claim 1, wherein the processor is configured to, if the first user has made a reservation for the object over a plurality of time slots, determine the possibility information for each of the plurality of time slots.

13. The information processing system according to claim 1, wherein a second user other than the first user is able to make an additional reservation for the object in a time slot in which the first user has already made a reservation for the object.

14. The information processing system according to claim 13, wherein the second user that is able to make the additional reservation is limited to a certain number.

15. The information processing system according to claim 1, wherein, if the first user has specified that a need to use the object by a reservation made in a time slot by the first user is small, a second user other than the first user is able to make an additional reservation for the object in the time slot.

16. The information processing system according to claim 1, wherein, if the first user has not specified that a need to use the object by a reservation made in a time slot by the first user is small, a second user other than the first user is unable to make an additional reservation for the object in the time slot.

17. The information processing system according to claim 1, wherein, if no user other than the first user has made an additional reservation for the object in a time slot in which the first user has already made a reservation for the object and if a predetermined time has already elapsed, it is not possible to cancel the reservation made by the first user.

18. The information processing system according to claim 1, wherein, regarding an additional reservation made by a second user other than the first user for the object in a first time slot in which the first user has already made a reservation for the object,
if the second user also makes a reservation for the object in a second time slot in which no reservation has been made, the second time slot being continued from or to the first time slot, the additional reservation made by the second user is accepted, and
if the second user does not make a reservation for the object in the second time slot or if the second user also makes a reservation for the object in a third time slot in which a reservation has already been made, the third time slot being continued from or to the first time slot, the additional reservation made by the second user is not accepted.

19. A non-transitory computer readable medium storing a program causing a computer to execute a process for executing processing for an object reserved by a user, the process comprising:
determining possibility information about a possibility that a user having reserved the object will actually use the object.

20. An information processing system that executes processing for an object reserved by a user, comprising:
means for determining possibility information about a possibility that a user having reserved the object will actually use the object.
